(19) United States
(12) Patent Application Publication
(10) Pub. No.: US 2026/0140417 A1
(43) Pub. Date: May 21, 2026

(54) NON-POLARIZED ELECTROCHEMICAL STRUCTURAL COLOR PIXELS

(71) Applicant: EWHA UNIVERSITY-INDUSTRY COLLABORATION FOUNDATION, Seoul (KR)

(72) Inventors: Jerome Kartham HYUN, Seoul (KR); Min-Ji KIM, Asan-si (KR)

(21) Appl. No.: 19/409,814

(22) Filed: Dec. 5, 2025

Related U.S. Application Data
(63) Continuation of application No. PCT/KR2025/018796, filed on Nov. 14, 2025.

(30) Foreign Application Priority Data
Nov. 15, 2024 (KR) 10-2024-0163030
Aug. 28, 2025 (KR) 10-2025-0120805

(51) Int. Cl. G02F 1/1523; G02F 1/157; G02F 1/1343; G02F 1/155

(52) U.S. Cl. CPC G02F 1/1525; G02F 1/157; G02F 1/13439; G02F 1/155

(57) ABSTRACT

The present disclosure relates to a non-polarized electrochemical structural color pixel. A non-polarized structural color pixel according to embodiments of the present disclosure integrates a nanohole metasurface formed in a dielectric layer with an electrochemical metal deposition-dissolution technique, thereby enabling dynamic expression of vivid and diverse colors without dependence on specific polarization conditions (i.e., without a polarizer).

### CROSS-REFERENCE TO RELATED APPLICATIONS

This application is a continuation of PCT Application No. PCT/KR2025/018796, filed on November 14, 2025, which claims priorities to Korean Patent Applications No. 10-2024-0163030 filed on November 15, 2024, and No. 10-2025-0120805 filed on August 28, 2025, all of which are hereby incorporated by reference in their entirety.

### TECHNICAL FIELD

The present disclosure relates to a non-polarized electrochemical structural color pixel.

This work was conducted with the financial support of the Seoul RISE (Regional Innovation System & Education) Center, funded by the Ministry of Education and the Seoul Metropolitan Government in 2025, under the project of the “Seoul RISE”. (2025-RISE-01-034-01)

### BACKGROUND

Conventional color display technologies primarily rely on dyes or pigments, which inherently limit color vividness and visibility. As a solution to overcome these limitations, structural color technologies that employ nanostructures and patterns precisely designed to induce optical resonance within the visible range have attracted considerable attention. The hue or intensity of such structural colors may be controlled by adjusting the dielectric contrast between the structure and its surrounding medium, or by precisely tuning structural parameters.

In particular, grating structures, which enhance optical resonance effects, are widely employed in designing color filters to improve color reproducibility. However, diffraction-based structural color pixels exhibit polarization dependence, which means their perceived color varies with the polarization state of incident light. This poses a critical limitation for practical applications, especially for display devices such as electronic paper. Adding an extra polarization layer complicates the device structure, increases manufacturing costs, and reduces energy efficiency.

Structural colors generated using nanostructures can sensitively respond to external stimuli (e.g., electricity, heat, light, and magnetic fields), thereby enabling dynamic color tuning in response to such stimuli.

For applications in displays, sensors, and information transmission devices, characteristics such as low-power operation, fast switching response, and polarization-independent optical behavior are required, and these characteristics can be effectively utilized in various fields. Furthermore, the advancement in this technology may significantly contribute to sustainable industrial development.

### Prior Art Document

### Patent Document

Korean Registered Patent No. 2737909

### DISCLOSURE OF THE INVENTION

### PROBLEMS TO BE SOLVED BY THE INVENTION

The present disclosure provides a non-polarized electrochemical structural color pixel.

However, problems to be solved by the present disclosure are not limited to the above-described problems, and although not described herein, other problems to be solved by the present disclosure can be clearly understood by those skilled in the art from the following descriptions.

### MEANS FOR SOLVING THE PROBLEMS

An aspect of the present disclosure provides a non-polarized structural color pixel, including a reflective substrate, a dielectric layer in which an array of nanoholes is formed, an electrolyte including a metal salt, and a transparent electrode, wherein the nanoholes have columnar structures, and a metal from the metal salt is electrochemically deposited and dissolved inside the nanoholes.

### EFFECTS OF THE INVENTION

The non-polarized structural color pixel according to embodiments of the present disclosure integrates a nanohole metasurface formed in a dielectric layer with an electrochemical metal deposition-dissolution technique, thereby enabling dynamic expression of vivid and diverse colors without dependence on specific polarization conditions (i.e., without a polarizer).

The non-polarized structural color pixel according to embodiments of the present disclosure may implement a desired reflected color by precisely controlling characteristics of a nanohole array formed in the dielectric layer. Further, the non-polarized structural color pixel may be reversibly altered through electrochemical metal deposition and dissolution, thereby enabling changes in color and optical properties of the pixel.

The non-polarized structural color pixel according to embodiments of the present disclosure may perform optical switching at a low driving voltage of about 1.4 V or less and at a low power density of about 0.5 mW/cm² or less, or about 0.3 mW/cm² or less. Bistability can be achieved by applying a low voltage, thereby enabling implementation with very low energy consumption.

The non-polarized structural color pixel according to embodiments of the present disclosure has a remarkably short stripping time. Thus, it can be advantageously applied to displays (for a non-limiting example, electronic paper displays) and optical devices that require fast response.

The non-polarized structural color pixel according to embodiments of the present disclosure may exhibit stable, reversible color changes and optical property transitions even after more than about 600 driving cycles.

The non-polarized structural color pixel according to embodiments of the present disclosure may exhibit a significantly high color reflectance of about 60% or more due to the absence of a polarizer.

### BRIEF DESCRIPTION OF THE DRAWINGS

FIG. 1A(i) to FIG. 1A(ii) and FIG. 1B(i) to FIG. 1B(iv) are schematic views each illustrating the driving of a non-polarized structural color pixel according to an embodiment of the present disclosure.

FIG. 2A(i) to FIG. 2A(viii) and FIG. 2B(i) to FIG. 2B(iii) illustrate: scanning electron microscope (SEM) images of a nanohole metasurface of the non-polarized structural color pixel before (upper) and after (lower) Cu electrodeposition (FIGS. 2A(i) to 2A(viii)); and an energy dispersive spectrometer (EDS) image of a pixel having a nanohole array with a period of 425 nm after Cu electrodeposition (FIGS. 2B(i) to 2B(iii)), according to an embodiment of the present disclosure.

FIG. 3A , FIG. 3B and FIG. 3C(i) to FIG. 3C(viii) illustrate: color changes depending on the period of the array of the nanoholes of the non-polarized structural color pixel (FIG. 3A); a graph of the applied voltage, corresponding current, and power density over time during an electrochemical Cu deposition-dissolution process (FIG. 3B); and a graph of the reflectance continuously measured during the electrochemical Cu deposition-dissolution process of the non-polarized structural color pixel (FIGS. 3C(i) to 3C(viii)), according to an embodiment of the present disclosure.

FIG. 4A and FIG. 4B illustrate: wavelength changes depending on the number of driving cycles of a pixel having a nanohole array with a period of 425 nm (FIG. 4A); and optical microscope images corresponding to Cu deposition and dissolution (FIG. 4B), according to an embodiment of the present disclosure.

FIG. 5A(i) to FIG. 5A(ii) and FIG. 5B illustrate: a graph of the applied voltage and corresponding current depending on Cu electrodeposition time (FIG. 5A(i) and FIG. 5A(ii)); and a power density graph depending on Cu electrodeposition time (FIG. 5B), according to an embodiment of the present disclosure.

### BEST MODE FOR CARRYING OUT THE INVENTION

Hereinafter, embodiments and examples of the present disclosure will be described in detail with reference to the accompanying drawings so that the present disclosure may be readily implemented by those skilled in the art. However, it is to be noted that the present disclosure is not limited to the embodiments and examples but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, a phrase in the form “A and/or B” means “A or B, or A and B”.

In the following description, exemplary embodiments of the present disclosure will be described in detail, but the present disclosure may not be limited thereto.

An aspect of the present disclosure provides a non-polarized structural color pixel, including a reflective substrate, a dielectric layer in which an array of nanoholes is formed, an electrolyte including a metal salt, and a transparent electrode, wherein the nanoholes have columnar structures, and a metal from the metal salt is electrochemically deposited and dissolved inside the nanoholes.

In an embodiment of the present disclosure, the non-polarized structural color pixel integrates a nanohole metasurface of the dielectric layer with an electrochemical metal deposition-dissolution technique, thereby enabling dynamic expression of vivid and diverse colors without dependence on specific polarization conditions (i.e., without a polarizer).

In an embodiment of the present disclosure, the reflective substrate may include one or more selected from Pt, Ag, Au, and Pd, but is not limited thereto.

The reflective substrate contributes to implementation of a structural color by reflecting incident light, and also serves as a working electrode to supply electrons and enable electrochemical metal deposition on the reflective substrate inside the nanoholes. The reflective substrate may have excellent chemical stability with respect to the electrolyte.

In an embodiment of the present disclosure, the reflective substrate may have a thickness of about 100 nm or more.

In an embodiment of the present disclosure, the dielectric layer may include one or more selected from TiO₂, SiO₂, Si, ZrO₂, RuO₂, IrO₂, CaO, SrO, BaO, MnO, CuO, CuO₂, Cu₂O₃, MoS₂, TiN, and WO₃, but is not limited thereto.

In an embodiment of the present disclosure, the dielectric layer may have a thickness of about 10 nm to about 1,000 nm, about 10 nm to about 900 nm, about 10 nm to about 800 nm, about 10 nm to about 700 nm, about 10 nm to about 600 nm, about 10 nm to about 500 nm, about 10 nm to about 400 nm, about 10 nm to about 300 nm, about 10 nm to about 200 nm, about 10 nm to about 150 nm, about 10 nm to about 100 nm, about 50 nm to about 1,000 nm, about 50 nm to about 900 nm, about 50 nm to about 800 nm, about 50 nm to about 700 nm, about 50 nm to about 600 nm, about 50 nm to about 500 nm, about 50 nm to about 400 nm, about 50 nm to about 300 nm, about 50 nm to about 200 nm, about 50 nm to about 150 nm, about 50 nm to about 100 nm, about 50 nm to about 80 nm, about 100 nm to about 1,000 nm, about 100 nm to about 900 nm, about 100 nm to about 800 nm, about 100 nm to about 700 nm, about 100 nm to about 600 nm, about 100 nm to about 500 nm, about 100 nm to about 400 nm, about 100 nm to about 300 nm, about 100 nm to about 200 nm, or about 100 nm to about 150 nm, but is not limited thereto.

In an embodiment of the present disclosure, the thickness of the dielectric layer may correspond to the height of the nanoholes.

In an embodiment of the present disclosure, the non-polarized structural color pixel may implement a passive reflective structural color due to the sophisticated optical properties of the metasurface of the array of the nanoholes. The passive reflective structural color may be an inherent property determined by the structural characteristics of the dielectric layer in which the array of the nanoholes is formed. Various passive reflective structural colors may be implemented by adjusting the period of the array of the nanoholes and the diameter and shape of the nanoholes.

In an embodiment of the present disclosure, the columnar structure of the nanoholes may include one or more selected from cylindrical, triangular-prism, quadrangular-prism, pentagonal-prism, hexagonal-prism, and star shapes-prism, but is not limited thereto.

In an embodiment of the present disclosure, the nanoholes may have a diameter of about 100 nm to about 500 nm. In another embodiment of the present disclosure, the nanoholes may have a diameter of 100 + 5l nm (where l is an integer from 0 to 80), i.e., about 100 nm to about 500 nm.

In an embodiment of the present disclosure, a period of the array of the nanoholes may be about 200 nm to about 900 nm.

In an embodiment of the present disclosure, the period of the array of the nanoholes may be 200 + 5k nm (where k is an integer from 0 to 100), i.e., about 200 nm to about 900 nm.

In an embodiment of the present disclosure, the period of the array of the nanoholes may belong to a first sub-period range of about 200 nm to about 500 nm, or may belong to a second sub-period range of about 500 nm to about 900 nm.

In an embodiment of the present disclosure, the period of the array of the nanoholes is a key factor that determines the color of the passive reflective structural color, and may be adjusted according to the color to be implemented.

In an embodiment of the present disclosure, the period of the array of the nanoholes may be about 1.5 times to about 2 times, about 1.5 times to about 1.9 times, about 1.5 times to about 1.8 times, about 1.5 times to about 1.7 times, about 1.5 times to about 1.6 times, about 1.6 times to about 2 times, about 1.6 times to about 1.9 times, about 1.6 times to about 1.8 times, about 1.6 times to about 1.7 times, about 1.7 times to about 2 times, about 1.7 times to about 1.9 times, or about 1.7 times to about 1.8 times the diameter of the nanoholes, but is not limited thereto.

In an embodiment of the present disclosure, the metal may include one or more selected from Cu, Ni, Ag, Zn, Pb, Bi, and Al, but is not limited thereto.

In an embodiment of the present disclosure, the metal salt may be dissociated in the electrolyte into metal ions and anions.

In an embodiment of the present disclosure, the metal salt may be a metal hydrate salt, a halide metal salt, or a combination of a metal ion and an organic ion.

In an embodiment of the present disclosure, the metal hydrate salt may be, for a non-limiting example, Cu(ClO₄)₂·6H₂O or Cu(NO₃)₂·3H₂O. The halide metal salt may be, for a non-limiting example, CuCl₂ or CuBr₂.

In an embodiment of the present disclosure, the metal salt may include one or more anions selected from ClO₄⁻, NO₃⁻, Cl⁻, Br⁻, and I⁻, but is not limited thereto. In particular, when the metal salt includes ClO₄⁻ as the anion, the electrochemical deposition-dissolution time (i.e., stripping time) of the metal may be reduced.

In an embodiment of the present disclosure, a solvent for the electrolyte may be any solvent conventionally used in electrochemical devices. The solvent may be, for a non-limiting example, water, a buffer solution in which KOH or NaOH is dissolved, or a sulfone-based solvent, such as sulfolane or dimethyl sulfoxide (DMSO).

In an embodiment of the present disclosure, the electrolyte may further include a polymer. In an embodiment of the present disclosure, the polymer may be, for a non-limiting example, polyvinyl butyral (PVB) or polyvinyl alcohol (PVA). In an embodiment of the present disclosure, the polymer may be formed as a film on the reflective substrate to protect the substrate and enhance the dissociation rate of the metal.

In an embodiment of the present disclosure, the transparent electrode may include one or more selected from indium tin oxide (ITO), fluorine-doped tin oxide (FTO), aluminum-doped zinc oxide (AZO), gallium-doped zinc oxide (GZO), indium zinc oxide (IZO), antimony-doped tin oxide (ATO), and indium gallium zinc oxide (IGZO), but is not limited thereto.

In an embodiment of the present disclosure, the non-polarized structural color pixel implements a color change by adjusting an electrochemical deposition-dissolution state of the metal.

In an embodiment of the present disclosure, in the non-polarized structural color pixel, structural changes may occur as the metal is electrochemically deposited and dissolved in the nanoholes, and the color may change reversibly.

In an embodiment of the present disclosure, the non-polarized structural color pixel may implement full-color reflective display without modifying the characteristics of the array of the nanoholes. It can be implemented by adjusting the electrochemical deposition-dissolution state of the metal while maintaining the structural characteristics of the array of the nanoholes (the period of the array of the nanoholes and the diameter and shape of the nanoholes).

In an embodiment of the present disclosure, the metal may be deposited over time on the reflective substrate through electrochemical deposition in a height direction of the nanoholes. The electrochemical deposition state of the metal may include: (1) no deposition; (2) partial filling of the nanohole with the metal; (3) complete filling of the nanohole with the metal; (4) over-deposition of the metal, forming a dome that protrudes beyond the nanohole surface; or (5) over-deposition of the metal, forming a continuous thin film beyond the nanohole surface. The color to be implemented may vary based on the corresponding state. In state (2), the height of the metal inside the nanohole may increase over time, thereby causing a change in color.

In an embodiment of the present disclosure, during dissolution of the electrochemically deposited metal, random (non-uniform) dissolution may occur. As a result, disordered metal nanoparticles may be formed, and black color may be implemented due to their broadband absorption.

In an embodiment of the present disclosure, the non-polarized structural color pixel may have a different electrochemical deposition pattern of the metal and a different resulting color implementation mechanism depending on the period of the array of the nanoholes. Specifically, when the period of the array of the nanoholes belongs to the first sub-period range, yellow, green, blue, pink, and red may be implemented due to shape changes of the over-deposited metal. When the period of the array of the nanoholes belongs to the second sub-period range, black, blue, green, and red may be implemented as electrochemical deposition time progresses.

In an embodiment of the present disclosure, electrochemical deposition of the metal may be performed by applying a negative (–) voltage to the working electrode.

In an embodiment of the present disclosure, electrochemical dissolution of the metal may be performed by applying a positive (+) voltage to the working electrode.

In an embodiment of the present disclosure, a difference in voltage applied during the electrochemical deposition-dissolution of the metal may be about 1.4 V or less, or may range from about 0.1 V to about 1.4 V, but is not limited thereto.

In an embodiment of the present disclosure, a power density consumed during the electrochemical deposition-dissolution of the metal may be about 0.5 mW/cm² or less, about 0.4 mW/cm² or less, about 0.3 mW/cm² or less, about 0.1 mW/cm² to about 0.5 mW/cm², about 0.1 mW/cm² to about 0.4 mW/cm², or about 0.1 mW/cm² to about 0.3 mW/cm², but is not limited thereto.

In an embodiment of the present disclosure, the non-polarized structural color pixel may perform optical switching at a low driving voltage of about 1.4 V or less and a low power density of about 0.5 mW/cm² or less, or about 0.3 mW/cm² or less, thereby exhibiting bistability due to its very low energy consumption.

In an embodiment of the present disclosure, after the metal is electrochemically deposited, the time required for the electrochemically deposited metal to be completely dissolved (i.e., stripping time) may be about 1 second or less, about 0.001 second to about 1 second, about 0.001 second to about 0.1 second, about 0.001 second to about 0.01 second, or about 0.001 second to about 0.005 second, but is not limited thereto.

In an embodiment of the present disclosure, due to the remarkably short stripping time, the non-polarized structural color pixel may be advantageously applied to displays (e.g., electronic paper displays) and optical devices that require fast response.

In an embodiment of the present disclosure, the non-polarized structural color pixel may exhibit stable, reversible color changes and optical property transitions even after more than about 600 driving cycles.

In an embodiment of the present disclosure, the non-polarized structural color pixel may exhibit a significantly high color reflectance of about 60% or more due to the absence of a polarizer.

Hereinafter, the present disclosure will be described in more detail with reference to Examples, but the present disclosure may not be limited thereto.

### MODE FOR CARRYING OUT THE INVENTION

### [Examples]

### Example 1: Fabrication of Non-polarized Structural Color Pixel

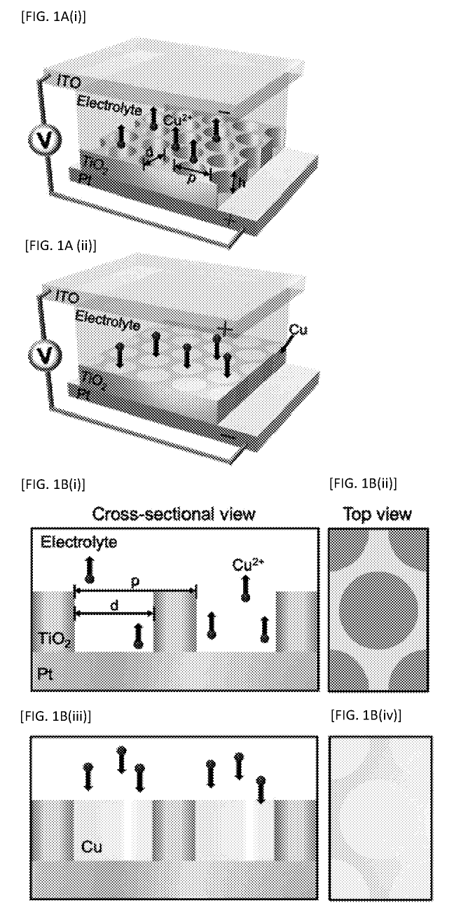

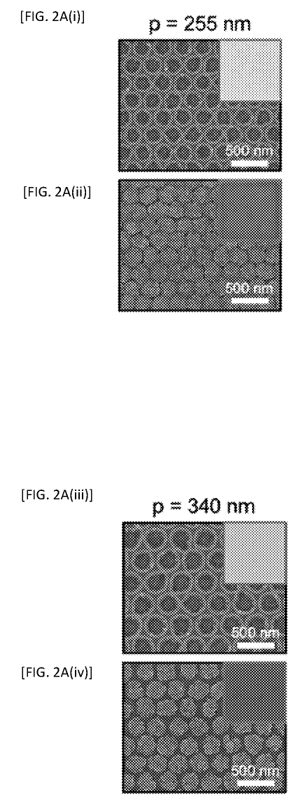

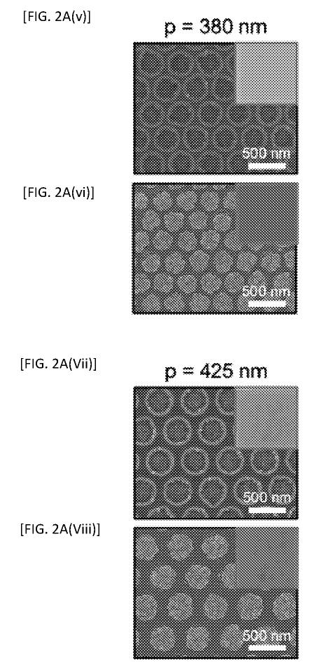

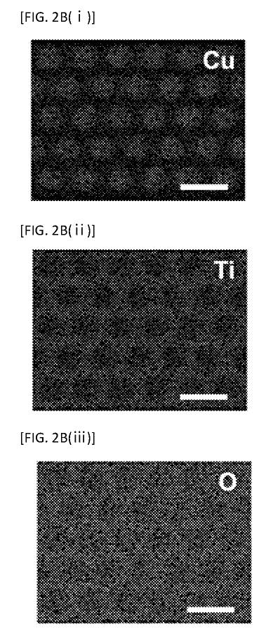

A non-polarized structural color pixel was fabricated using a Pt reflective substrate, a TiO₂ dielectric in which a nanohole array was formed through a lithographic process, an electrolyte containing Cu²⁺, and an ITO (indium tin oxide) transparent electrode serving as a counter electrode (FIG. 1A(i) to FIG. 1A(ii), and FIG. 1B(i) to FIG. 1B(iv)). The electrolyte was prepared by dissolving 0.9 M Cu(ClO₄)₂·6H₂O and 0.1 M CuBr₂ in a mixed solvent of dimethyl sulfoxide (DMSO) and water at a weight ratio of 80:20. The electrolyte may further contain 0.05 wt% of a polymer material, such as polyvinyl butyral (PVB) or polyvinyl alcohol (PVA). The polymer material may be formed as a film on the reflective substrate to protect the substrate and enhance the dissociation rate of the metal. FIG. 1A(i) to FIG. 1A(ii), and FIG. 1B(i) to FIG. 1B(iv) are schematic views of the non-polarized structural color pixel, and respectively illustrate a state where Cu metal is dissolved in the electrolyte (non-deposition state) and a state where Cu metal is electrically deposited inside the nanoholes. FIGS. 2A(i), 2A(iii), 2A(v), and 2A(vii) are scanning electron microscope (SEM) images of the non-polarized structural color pixel, showing a titanium dioxide (TiO₂) nanohole metasurface formed with nanohole arrays having various periods (255 nm, 340 nm, 380 nm, and 425 nm). The inset shows the corresponding reflected colors measured by optical microscopy. FIGS. 2A(ii), 2A(iv), 2A(vi), and 2A(viii) show the structure after Cu electrodeposition in the nanoholes. Likewise, the inset shows the corresponding reflected colors measured by optical microscopy, and for periods of 340 nm or more, it exhibits blue-hued colors. FIGS. 2B(i) to 2B(iii) show energy dispersive spectrometer (EDS) measurement results obtained when the nanoholes of a 425-nm-period array are fully filled with Cu through electrodeposition.

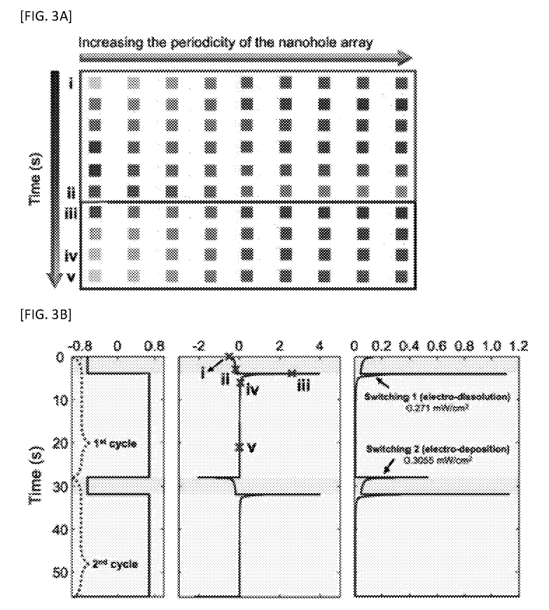

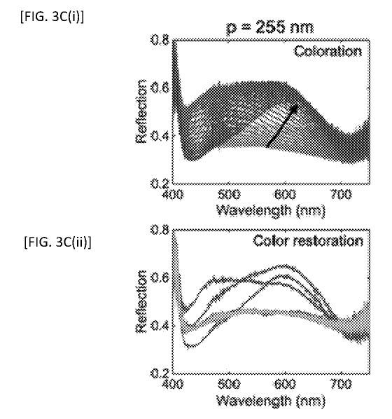

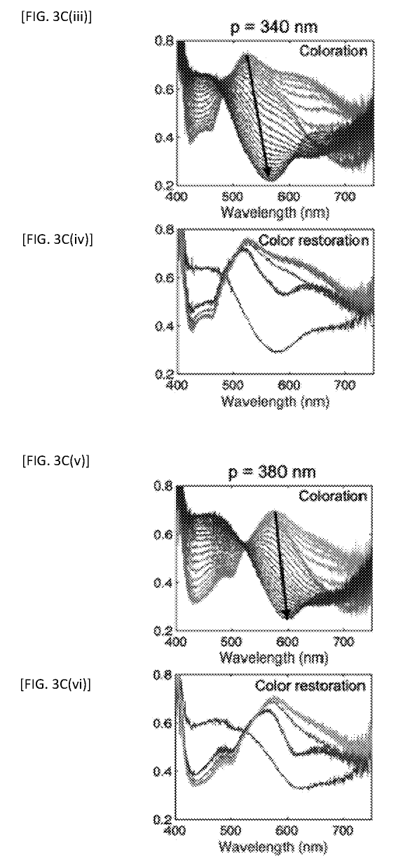

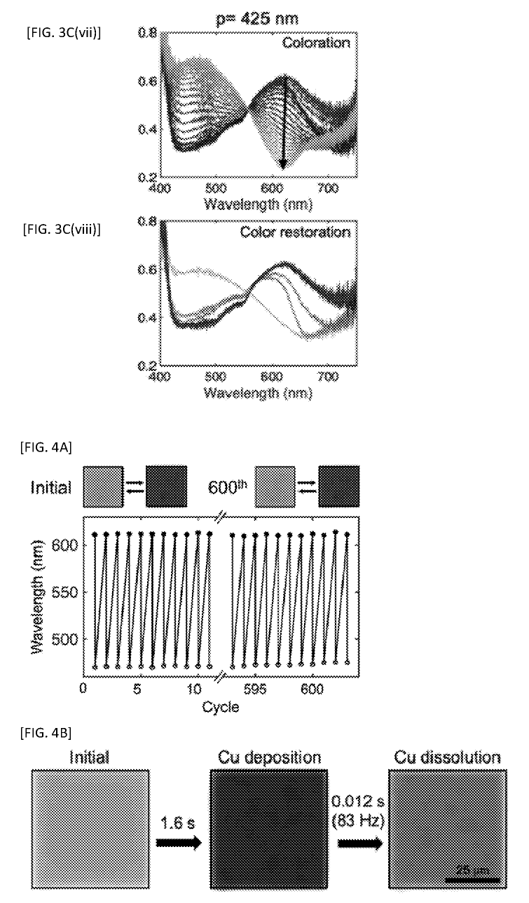

Non-polarized structural color pixels were fabricated by adjusting the period of a nanohole array within a range of 200 nm to 900 nm, and color changes during an electrochemical deposition-dissolution process were measured (FIG. 3A). FIG. 3B is a graph of the applied voltage, corresponding current, and power density over time during the electrochemical deposition-dissolution process. First, for electrodeposition of metal, -0.65 V was applied for 3.2 seconds (i, ii). When a negative (-) voltage is applied, electrons are injected into a reflective substrate serving as a working electrode, causing a metal salt to be deposited as metal particles, thereby inducing structural changes. In the state ii, Cu metal completely fills nanoholes after 3.2 seconds of deposition. Then, for electro-dissolution of metal, +0.7 V was applied for 13 seconds (iii, iv, v). When a positive (+) voltage is applied, anions (Br) react in the counter electrode (ITO) and the deposited metal particles inside the nanoholes are converted back into the metal salt. As a result, the deposited metal is dissolved and the array of the nanoholes is restored to its original state. When +0.7 V is applied, the Cu metal can be completely dissolved within 1 second. A difference in voltage applied during the electrochemical deposition-dissolution process remains stable at 1.4 V or less. Further, the power densities consumed during voltage switching were 0.271 mW/cm² and 0.3055 mW/cm² (average: 0.3 mW/cm²), thereby confirming that the electrochemical structural color pixel of the present disclosure operates with low power consumption.

Each of FIGS. 3C(i) to 3C(viii) is a graph of the reflectance continuously measured during the deposition (FIGS. 3C(i), 3C(iii), 3C(v), and 3C(vii)) and dissolution (FIGS. 3C(ii), 3C(iv), 3C(vi), and 3C(viii)) processes of the non-polarized structural color pixel depending on the period of the array of the nanoholes. It can be seen that as the period of the array of the nanoholes increases, the reflectance dip shifts toward the red region. Further, in each nanohole array, a comparison of the reflectance dips before and after Cu deposition shows wavelength shifts of 100 nm or more after metal deposition. Furthermore, in each nanohole array, the measured reflectance values averaged above 60%, indicating high reflectance. Through metal deposition, the following states may be implemented: (1) no deposition; (2) partial filling of the nanohole with the metal; (3) complete filling of the nanohole with the metal; (4) over-deposition of the metal, forming a dome that protrudes beyond the nanohole surface; or (5) over-deposition of the metal, forming a continuous thin film beyond the nanohole surface. When the array of the nanoholes has a relatively small period of 500 nm or less, yellow, green, blue, pink, and red can be implemented due to shape changes of the over-deposited metal. When the array of the nanoholes has the smallest period (255 nm), Cu is over-deposited beyond the nanohole surface, resulting in implementation of a red color. Although not shown in the drawings, when the array of the nanoholes has a period of 500 nm or more, full-color display, including black, can be implemented in a single pixel through electrodeposition. By applying a fixed voltage (e.g., -0.65 V) to a single pixel and adjusting the voltage application time, various color changes from black to blue, green, and red can be implemented. In this case, when the metal nanoparticles deposited inside the nanoholes are disorderedly dissociated, black can be implemented through broadband absorption resulting from the disordered arrangement of the metal nanoparticles.

For a structural color pixel having a nanohole array with a period of 425 nm, a reflectance spectrum was measured over repeated cycles (FIG. 4A and FIG. 4B). In each cycle, -0.65 V was applied for 1.6 seconds to deposit Cu, and +0.7 V was applied for 0.012 seconds (i.e., 83 Hz) to dissolve Cu. Referring to the optical microscope images of FIG. 4A, a comparison of the reflected colors after the 1st and 600th cycles shows no remarkable color change, which confirms driving stability.

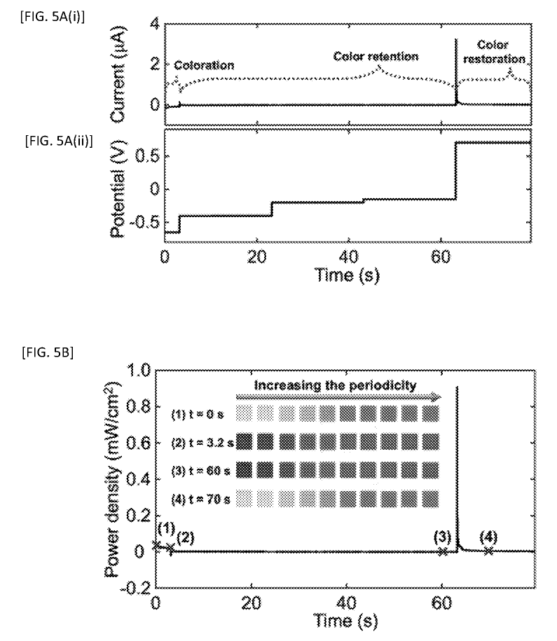

FIG. 5A(ii) shows a graph of the applied voltage and FIG. 5A(i) shows a graph of the corresponding current depending on electrodeposition time, and FIG. 5B shows a power density graph depending on electrodeposition time. The optical microscope images inserted in FIG. 5B were captured at 0 seconds, 3.2 seconds, 60 seconds, and 70 seconds, visually demonstrating color retention and stability over time during Cu deposition. As shown in FIG. 5A(i), FIG. 5A(ii), and FIG. 5B, the color can be maintained for more than 60 seconds when a low voltage is applied for color retention. It was confirmed that, due to the low power density, color retention can be achieved with low energy consumption.

The above description of the present disclosure is provided for the purpose of illustration, and it would be understood by those skilled in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A non-polarized structural color pixel, comprising
a reflective substrate, a dielectric layer in which an array of nanoholes is formed, an electrolyte including a metal salt, and a transparent electrode,
wherein the nanoholes have columnar structures, and
a metal from the metal salt is electrochemically deposited and dissolved inside the nanoholes.

2. The non-polarized structural color pixel of claim 1,
wherein the reflective substrate includes one or more selected from Pt, Ag, Au, and Pd.

3. The non-polarized structural color pixel of claim 1,
wherein the dielectric layer includes one or more selected from TiO₂, SiO₂, Si, ZrO₂, RuO₂, IrO₂, CaO, SrO, BaO, MnO, CuO, CuO₂, Cu₂O₃, MoS₂, TiN, and WO₃.

4. The non-polarized structural color pixel of claim 1,
wherein the dielectric layer has a thickness of 10 nm to 1,000 nm.

5. The non-polarized structural color pixel of claim 1,
wherein the columnar structure of the nanoholes includes one or more selected from cylindrical, triangular-prism, quadrangular-prism, pentagonal-prism, hexagonal-prism, and star shapes-prism.

6. The non-polarized structural color pixel of claim 1,
wherein the nanoholes have a diameter of 100 nm to 500 nm.

7. The non-polarized structural color pixel of claim 1,
wherein a period of the array of the nanoholes is 200 nm to 900 nm.

8. The non-polarized structural color pixel of claim 7,
wherein the period of the array of the nanoholes is 200 nm to 500 nm.

9. The non-polarized structural color pixel of claim 7,
wherein the period of the array of the nanoholes is 500 nm to 900 nm.

10. The non-polarized structural color pixel of claim 1,
wherein the period of the array of the nanoholes is 1.5 times to 2 times the diameter of the nanoholes.

11. The non-polarized structural color pixel of claim 1,
wherein the metal includes one or more selected from Cu, Ni, Ag, Zn, Pb, Bi, and Al.

12. The non-polarized structural color pixel of claim 1,
wherein the metal salt includes one or more anions selected from ClO₄⁻, NO₃⁻, Cl⁻, Br⁻, and I⁻.

13. The non-polarized structural color pixel of claim 1,
wherein the electrolyte further includes a polymer.

14. The non-polarized structural color pixel of claim 1,
wherein the transparent electrode includes one or more selected from indium tin oxide (ITO), fluorine-doped tin oxide (FTO), aluminum-doped zinc oxide (AZO), gallium-doped zinc oxide (GZO), indium zinc oxide (IZO), antimony-doped tin oxide (ATO), and indium gallium zinc oxide (IGZO).

15. The non-polarized structural color pixel of claim 1,
wherein the non-polarized structural color pixel implements a color change by adjusting an electrochemical deposition-dissolution state of the metal.

16. The non-polarized structural color pixel of claim 1,
wherein a difference in voltage applied during the electrochemical deposition-dissolution of the metal is 1.4 V or less.

17. The non-polarized structural color pixel of claim 1,
wherein a power density consumed during the electrochemical deposition-dissolution of the metal is 0.5 mW/cm² or less.

18. The non-polarized structural color pixel of claim 1,
wherein, after the metal is electrochemically deposited,
the time required for the electrochemically deposited metal to be completely dissolved is 1 second or less.

19. The non-polarized structural color pixel of claim 1,
wherein the non-polarized structural color pixel exhibits a color reflectance of 60% or more.

20. The non-polarized structural color pixel of claim 1,
wherein the non-polarized structural color pixel is used for electronic paper displays.
